(19) United States
(12) Patent Application Publication
(10) Pub. No.: US 2026/0321115 A1
(43) Pub. Date: Oct. 15, 2026

(54) VIRTUAL CONTROLLER BASED FIRE ALARM SYSTEM

(71) Applicant: Honeywell International Inc., Charlotte, NC (US)

(72) Inventors: Sudeep Jayakumar Duge, Bengaluru (IN); Mandar Himmat Nandale, Bengaluru (IN); Sameer Tripathi, Bengaluru (IN)

(21) Appl. No.: 19/176,631

(22) Filed: Apr. 11, 2025

(51) Int. Cl. G08B 17/00; G08B 25/10; G08B 25/14

(52) U.S. Cl. CPC G08B 17/00; G08B 25/10; G08B 25/14

(57) ABSTRACT

Devices, methods, and systems for a virtual controller based fire alarm system are described herein. An example device for a virtual controller based fire alarm system includes a virtual controller storing control logic that when executed, causes the virtual controller to receive an indication of a fire alarm event from a standalone fire sensing device, and send a control command to the standalone fire sensing device to initiate a response to the fire alarm event by the standalone fire sensing device.

### TECHNICAL FIELD

The present disclosure relates generally to devices, methods, and systems for a virtual controller based fire alarm system.

### BACKGROUND

Large facilities (e.g., buildings), such as commercial facilities, office buildings, hospitals, apartment complexes, manufacturing plants, large warehouses, airport terminals, train stations, and the like, may have a fire alarm system that can be triggered during an emergency event (e.g., a fire) to provide guidance to occupants of the facility, such as, for instance, a warning for the occupants to evacuate or control operations like door releases, lift operations, and mitigation operations (e.g., fire extinguishing and smoke control). For example, a fire alarm system may include a fire control panel and a plurality of fire sensing devices (e.g., sounders and/or smoke detectors), located throughout the facility (e.g., on different floors and/or in different rooms of the facility) that can sense a fire occurring in the facility and provide an audio notification of the fire to the occupants of the facility via alarms. The fire sensing devices may be wired in a loop formation in communication with the fire control panel to relay that an emergency event has been detected.

Physical fire control panels, however, are costly to install, especially in small-scale residences whose fire alarm systems typically include fewer fire sensing devices and modules throughout the residence. Further, in large facilities, multiple physical fire control panels are be installed to support the extensive fire alarm system needed for the facility to comply with safety requirements. For instance, a fire control panel may need to be installed on each floor of a multi-level facility, or more than one fire control panel may need to be installed on a single floor of a large facility to accommodate the large number of fire sensing devices. There are major cost concerns with installing multiple control panels and additional wiring. Further, when a control panel is experiencing a failure, the fire alarm system may be interrupted which introduces major risk to the occupants of the facility.

### BRIEF DESCRIPTION OF THE DRAWINGS

FIG. 1 illustrates an example of a fire alarm system including a virtual controller based fire panel in accordance with an embodiment of the present disclosure.

FIG. 2 illustrates an example of a fire alarm system including a virtual controller based fire panel in accordance with an embodiment of the present disclosure.

FIG. 3 illustrates an example of a fire alarm system including a virtual controller based fire panel in accordance with an embodiment of the present disclosure.

FIG. 4 illustrates a fire alarm system including a virtual controller based fire panel in accordance with an embodiment of the present disclosure.

### DETAILED DESCRIPTION

Devices, methods, and systems for a virtual controller based fire alarm system are described herein. An example device for a fire alarm system includes a virtual controller storing control logic that when executed, causes the virtual controller to receive an indication of a fire alarm event from a standalone fire sensing device and send a control command to the standalone fire sensing device to initiate a response to the fire alarm event by the standalone fire sensing device.

As noted above, previous approaches for installing a fire alarm system in a facility are a hugely cost-intensive process. For example, previous approaches for such fire alarm system installation may involve installing a fire control panel to support only a few fire sensing devices and modules, or installing many control panels at various points throughout a facility to maintain compliance.

Additionally, as most fire safety systems are becoming cloud-based, systems are becoming less hardware dependent, and complex processing can be handled virtually. For instance, in traditional fire alarm panels, in case of failure of the main controller, the whole fire alarm control panel (FACP) system goes down. Traditionally for multistory or large sites with networking needs, installation is time-consuming, costly, and complex. Network cards are needed to have global cause-and-effect rules and copper/fiber cabling is needed to network multiple buildings, which poses significant costs. In the event of a firmware upgrade of the main controller, the entire site is down. Additionally, if the main controller firmware upgrade fails or if the main controller fails, then the panel needs to be replaced. Traditional hardware-dependent systems are failure-prone and difficult to debug.

In contrast, embodiments of the present disclosure relate to a virtual controller based fire alarm system having a fail safe (redundancy) mode in case of failure. Fire safety systems for small-scale residences, high-rise buildings, densely populated areas, or regions with high growth rates can utilize such virtual controller based fire alarm systems to provide a safe, cost-effective solution to managing and operating a fire safety system.

Embodiments of the present disclosure can configure a virtual controller to send control commands to an edge controller such as a fire loop control module. The fire loop control module may be connected to physical fire panel devices via a wired or wireless connection. Embodiments of the present disclosure can comprise a virtual controller that functions as a container or virtual machine. The virtual controller may be capable of running fire panel control logic.

Further, embodiments of the present disclosure may include a fire loop control module that can communicate with wireless mesh devices or physical devices. Embodiments of the present disclosure may also include a loop controller that can communicate with the virtual controller through a gateway device. If the fire loop control module detects any alarm event, it may send an indication of the alarm event to the virtual controller. The virtual controller may run control logic (e.g., Cause and Effect logic) to determine an appropriate response to the alarm event and send the appropriate control commands to the fire loop control module. The fire loop control module can further activate and/or deactivate output devices (e.g., fire sensing devices) according to the control commands.

Embodiments of the present disclosure can include orchestration logic that, upon failure of the virtual controller, may sense and choose another virtual controller to drive the control logic so that the fire alarm system may continue to operate. In the event that a fire loop control module fails to communicate with the virtual controller, the virtual controller may enter a fail safe mode in which minimum control logic/cause and effect logic may be controlled by the fire loop control module. Further, in the event that an internet-of-things (IOT) standalone device (e.g., sensor or detector) communicates with the virtual controller, based on the events sensed by the standalone device, the virtual controller can activate standalone wireless modules present on the premises.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

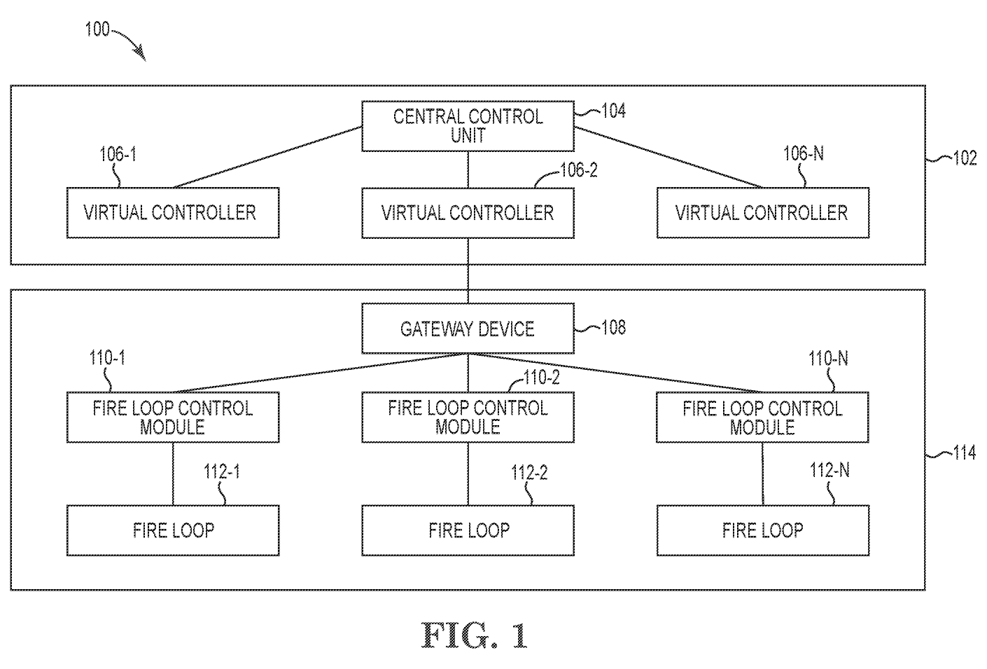

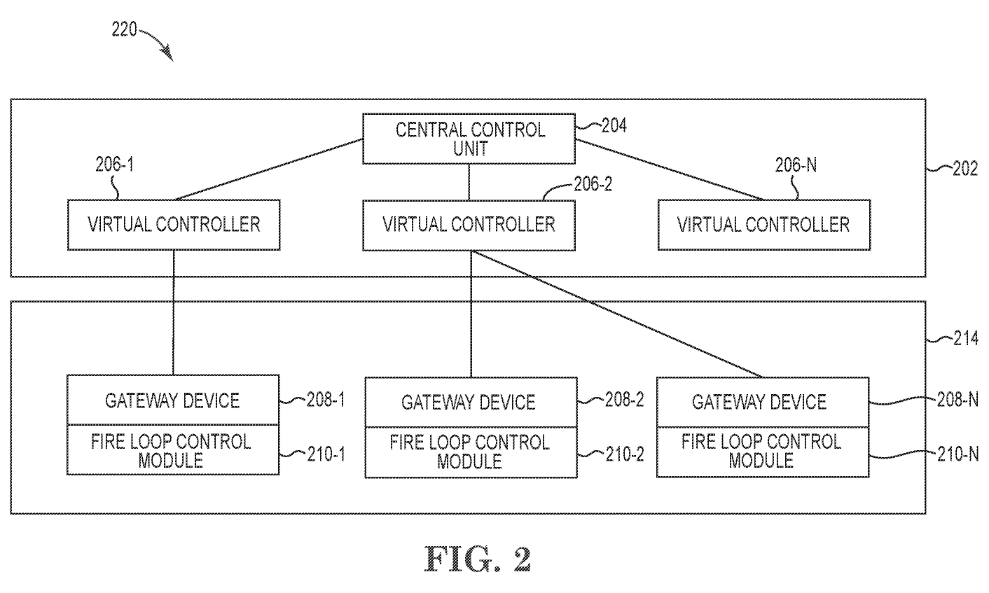

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

As used herein, “a”, “an”, or “a number of” something can refer to one or more such things, while “a plurality of” something can refer to more than one such things. For example, “a number of components” can refer to one or more components, while “a plurality of components” can refer to more than one component. Additionally, the designator “N”, as used herein, particularly with respect to reference numerals in the drawings, indicates that a number of the particular feature so designated can be included with embodiments of the present disclosure.

FIG. 1 illustrates an example of a fire alarm system 100 including a virtual controller based fire panel in accordance with an embodiment of the present disclosure. For example, a fire alarm system 100 may include a remote computing device 102 and a facility (e.g., building site) 114. The remote computing device can include a central control unit 104 and a plurality of virtual controllers 106-1, 106-2, 106-N, which can collectively be referred to as virtual controllers 106. The remote computing device can be used to manage the operation of fire alarm system 100 at building site 114.

The building site 114 can include a gateway device 108 in communication with a plurality of fire loop control modules 110-1, 110-2, 110-N, which can collectively be referred to as fire loop control modules 110. Each respective fire loop control module 110 may be in communication with a different one of fire loops 112-1, 112-2, 112-N (e.g., fire loop control module 110-1 is in communication with fire loop 112-1, fire loop control module 110-2 is in communication with fire loop 112-2, etc.), which may be in a wired or wireless configuration. Each respective wireless/wired loops 112-1, 112-2, 112-N may include a plurality of fire sensing devices in a loop formation (e.g., a configuration in which multiple devices are wired together in a sequence or ring). The fire loops are not limited to a particular number of fire sensing devices and more or fewer devices may be included within the fire loop. The fire sensing devices within the fire loop may be smoke detectors, heat sensors, or alarm sounders, for example.

The remote computing device 102 may include a central control unit 104 (e.g., orchestrator) for controlling and managing various components within the fire system 100 (e.g., the fire sensing devices of loops 112-1, 112-2, 112-N). In previous approaches, a fire alarm control panel physically installed within a facility may function as a central control unit for managing fire systems within facilities. However, embodiments described herein allow for a central control unit 104 to reside within a remote computing device 102. The remote computing device 102 may be cloud-based, physically located in a separate location from the building site 114 (e.g., off-premise), or located within the building site 114 (e.g., on-premise) in some examples. The central control unit 104 may include orchestration logic for managing virtual controllers 106. Orchestration logic may refer to the predefined rules and automated processes that coordinate fire system components to ensure an effective and timely response to fire alarm events. For example, orchestration logic can include fire detection, alerts, suppression, and management of fire system components.

For instance, virtual controller 106 can control the operation of (e.g., actions performed by) the fire sensing device of fire loops 112. The virtual controllers 106 can receive (e.g., collect) data, such as, for instance, real-time operational data, from fire sensing devices of fire loops 112. Such data can include, for instance, current operational statuses, operational states, and/or properties of the fire sensing devices within fire loops 112. As an additional example, the virtual controllers 106 can receive signals (e.g., alarm signals) from the fire loops 112 indicating that an emergency event (e.g., a fire alarm event) is occurring at the building site 114.

Each respective virtual controller may be assigned control of the devices of a different respective fire loop control module 110. For example, virtual controller 106-1 may control fire loop control module 110-1, virtual controller 106-2 may control fire loop control module 110-2, and virtual controller 106-N may control fire loop control module 110-N. Alternatively, virtual controller 106-2 may control fire loop control 110-1. Embodiments are not limited to specific arrangements and additional configurations are possible.

For example, remote computing device 102 may include a central control unit 104 and a plurality of virtual controllers 106, a gateway device 108 in communication with the remote computing device 102 and a plurality of fire loop control modules 110, and a different respective plurality of fire sensing devices in communication with each respective one of the plurality of fire loop control modules 110, wherein each respective one of the plurality of fire loop control modules 110 are configured to receive control commands from a virtual controller of the plurality of virtual controllers 106 via the gateway device 108 for controlling the plurality of fire sensing devices in communication with that respective fire loop control module.

For instance, as illustrated in FIG. 1, fire loop control module 110-1 may control the fire sensing devices of fire loop 112-1, fire loop control module 110-2 may control the fire sensing devices of fire loop 112-2, and fire loop control module 110-N may control the fire sensing devices of fire loop 112-N. Alternative configurations are possible, for example, fire loop control module 110-2 may control the fire sensing devices of both fire loop 112-1 and fire loop 112-N.

The fire loops 112 (e.g., the devices of the fire loops) may be directly monitored and controlled by virtual controllers 106 or may be monitored and/or controlled by fire loop control modules 110 in communication with the virtual controllers 106 via a gateway device 108. Although only one gateway device is illustrated in FIG. 1, additional gateway devices may be utilized. Gateway device 108 may serve as a bridge between different networked components within fire system 100, such as fire loop control modules 110 and virtual controllers 106. Gateway device 108 may function by converting signals between different communication protocols to integrate older systems and modern networks, for example.

The fire loop control modules 110 may serve as an interface for connecting and/or managing the fire sensing devices of each fire loop 112 installed within building site 114. The fire loop control modules 110 may monitor the fire sensing devices of each respective fire loop 112 for alarms (e.g., fire or smoke detections), faults (e.g., open or short circuits), or other events and may communicate the status of the fire sensing devices to the virtual controller 106. The fire loop control module may also be used to identify each fire sensing device of a fire loop 112 by its unique address for precise detection within addressable fire alarm systems.

Fire loops 112 can include, in addition to devices such as fire sensing devices, fans and/or dampers that can perform smoke control operations (e.g., pressurizing, purging, exhausting, etc.) during a fire, and/or sprinklers that can provide water to extinguish a fire, among other components of the fire alarm system 100.

As described previously, the fire sensing devices may be configured in a loop, either wired or wireless. This arrangement allows for redundancy within the fire alarm system such that if one part of the loop is damaged, communication can continue in the opposite direction.

As illustrated in FIG. 1, gateway device 108, fire loop control modules 110, and fire loops 112 can all be physically located within building site 114, but embodiments are not limited to such an arrangement. For example, gateway device 108 may be located remotely from building site 114 in some embodiments.

FIG. 2 illustrates an example of a fire alarm system 220 including a virtual controller based fire panel in accordance with an embodiment of the present disclosure. Fire alarm system 220 may illustrate an alternative configuration of fire system 100, as described in connection with FIG. 1. A remote computing device 202 including a central control unit 204 and a plurality of virtual controllers 206 may be used to manage the operation of fire alarm system 220 at a facility (e.g., building site 214). The building site 214 can include a plurality of gateway devices 208-1, 208-2, 208-N each in communication with (e.g., coupled to) a different respective fire loop control module 210-1, 210-2, 210-N (e.g., gateway 208-1 is coupled to fire loop control module 210-1, gateway 208-2 is coupled to fire loop control module 210-2, etc.), as illustrated in FIG. 2.

In the example illustrated in FIG. 2, remote computing device 202 may be cloud-based, physically located in a separate (e.g., remote) location from the building site 214 (e.g., off-premises), or located within the building site 214 (e.g., on-premises) in some examples. The central control unit 204 may include orchestration logic for managing virtual controllers 206.

Virtual controllers 206 can control the operation of (e.g., actions performed by) fire sensing devices managed by fire loop control modules 210. The virtual controllers 206 can receive (e.g., collect) data, such as, for instance, real-time operational data, from fire loop control modules 210. Such data can include, for instance, current operational statuses, operational states, and/or properties of the fire sensing devices of fire loops managed by fire loop control modules 210. As an additional example, the virtual controllers 206 can receive signals (e.g., alarm signals) from the fire loop control modules 210 indicating that an emergency event (e.g., a fire) is occurring at the building site 214.

Although not illustrated in FIG. 2, each fire loop control module may be in communication with a fire loop. The fire loop may include a plurality of fire sensing devices in a loop formation, either wired or wireless, as previously described herein (e.g., in connection with FIG. 1).

In the example illustrated FIG. 2, each respective virtual controller 206 may be in communication with a different respective fire loop control module 210 through an associated gateway device 208. For example, virtual controller 206-1 may control the functioning of fire loop control module 210-1 through gateway device 208-1 and virtual controller 206-2 may control the functioning of fire loop control module 210-2 through gateway device 208-2. Virtual controller 206-N may control the functioning of fire loop control module 210-N during normal operation of fire system 220. However, in the instance of a failure event of virtual controller 206-N, virtual controller 206-2 may take control of fire loop control module 210-N, as illustrated in FIG. 2. For instance, upon failure of a virtual controller (e.g., 206-N), central control unit 204 may select another virtual controller (e.g., 206-2) to drive the control logic such that fire system 220 may continue to operate. As such, one virtual controller of the plurality of virtual controllers 206 may be configured to control a number of the plurality of fire loop control modules in parallel. For example, during a failure event of a virtual controller of the plurality of virtual controllers 206, the central control unit 204 may be configured to select a different virtual controller of the plurality of virtual controllers 206 to control the fire loop control module of the plurality of fire loop control modules 210 having the failure event.

Additionally, the plurality of virtual controllers 206 may be configured to receive an indication of a fire alarm event from a corresponding fire loop control module (e.g., virtual controller 206-1 can receive an indication of a fire alarm event from fire loop control module 210-1 via gateway device 208-1, virtual controller 206-2 can receive an indication of a fire alarm event from fire loop control module 210-2 via gateway device 208-2, etc.), run cause and effect logic in response to receiving the indication of the fire alarm event from the corresponding fire loop control module, and send a control command to the corresponding fire loop control module to initiate a response to the fire alarm event by the fire sensing devices that are in communication with that fire loop control module.

The control command may be to activate (e.g., the response can comprise activating) the plurality of fire sensing devices in communication with that respective fire loop control module. Alternatively, the control command may be to deactivate (e.g., the response can comprise deactivating) the plurality of fire sensing devices in communication with that respective fire loop control module.

Additionally, during a failure event of remote computing device 202, each respective one of the plurality of fire loop control modules 210 may be configured to control the plurality of fire sensing devices of its corresponding fire loop 212. In this way, operation of fire system 220 can proceed without interruption.

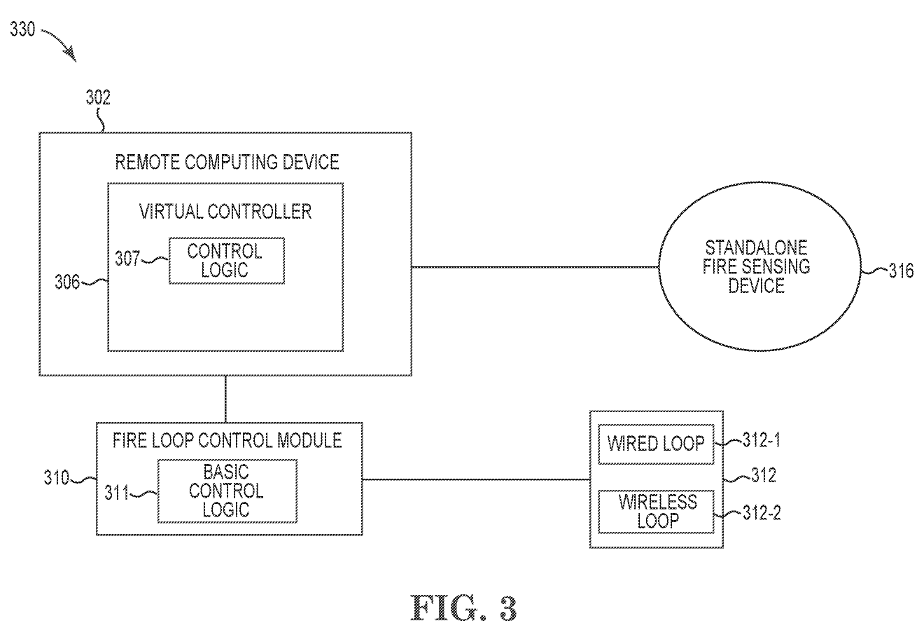

FIG. 3 illustrates an example of a fire alarm system 330 including a virtual controller based fire panel in accordance with an embodiment of the present disclosure. Remote computing device 302 may be remote computing device 102 or remote computing device 202, as described in connection with FIGS. 1 and 2, respectively.

In the fire system 330 depicted in FIG. 3, remote computing device 302 may include virtual controller 306. Virtual controller may include control logic 307 to manage and operate fire loop control module 310. Fire loop control module 310 may include basic control logic. Fire loop control module 310 may be one of fire loop control modules 110 or one of fire loop control module 210, as described in connection to FIGS. 1 and 2, respectively.

Remote computing device 302 may be in communication (e.g., direct communication) with a standalone fire sensing device 316. A standalone fire sensing device may refer to a fire alarm system that includes a single fire sensing device. For instance, virtual controller 306 may be configured to send control commands directly to standalone fire sensing device 316 through wireless communication. As an example, the standalone fire sensing device may be located within a small residence in which only one fire sensing device is needed or required in order to maintain a safe environment. The standalone fire sensing device 316 may be any suitable fire sensing device such as a smoke detector, heat sensor, or alarm sounder, for example. Standalone fire sensing device 316 may be an Internet-of-Things (IOT) based sensor. Standalone fire sensing device may not require a fire loop control module to facilitate communication with virtual controller 306.

Virtual controller 306 may also be in communication with fire loop control module 310. Fire loop control module 310 may be in communication with and control operation of a fire loop 312 (e.g., the fire sensing devices of fire loop 312). Fire loop 312 may include both a wired loop 312-1 and wireless loop 312-2, as illustrated in FIG. 3, but embodiments are not so limited. Both the wired loop and wireless loop of fire loop 312 may include a plurality of fire sensing devices in a loop configuration. For example, the virtual controller 306 may be configured to manage a plurality of fire sensing devices wired in a loop via a fire loop control module 310 in communication with the plurality of fire sensing devices wired in the loop 312.

Fire loop control module 310 and fire loop 312 may be located in a separate location from standalone fire sensing device 316. For example, standalone fire sensing device 316 may be located in one residence and fire loop control module 310 and fire loop 312 may be located in a separate residence. Alternatively, fire loop control module 310 and fire loop 312 may also be located in separate physical locations.

Virtual controller 306 may control the operation of standalone fire sensing device 316 and fire loop control module 310 simultaneously. For example, virtual controller 306 may control the operation of standalone fire sensing device 316 in addition to, or at the same time as, fire loop control module 310.

For example, virtual controller 306 of fire system 330, may receive an indication of a fire alarm event occurring via fire loop control module 310 in communication with a plurality of fire sensing devices of a fire loop 312. Virtual controller 306 may determine a response to the fire alarm event (e.g. using control logic 307, including, for instance, cause and effect logic) and send a control command to the fire loop control module 310 to initiate the response to the fire alarm event by at least one of the plurality of fire sensing devices.

The control command may be to activate (e.g., the response can comprise activating) a physical indicator on at least one of the plurality of fire sensing devices of the fire loop 312. Alternatively, the control command may be to deactivate (e.g., the response can comprise deactivating) a physical indicator on at least one of the plurality of fire sensing devices within the fire loop 312.

The virtual controller 306 may receive another indication of the fire alarm event occurring via a different fire loop control module in communication with a different plurality of fire sensing devices, determine an additional response to the fire alarm event, and send a control command to the different fire loop control module to initiate the additional response to the fire alarm event by at least one of the different plurality of fire sensing devices

Fire loop control module 310 may include basic control logic 311. In the instance that fire loop control module 310 fails to communicate with virtual controller 306, fire loop control module 310 may enter fail safe mode in which basic control logic (e.g., cause and effect logic) 311 will be run by fire loop control module 310 for managing the operation of fire loop 312. For example, fire loop control module 310 includes basic control logic 311 to control the plurality of fire sensing devices wired in the loop during a failure event of the virtual controller 306.

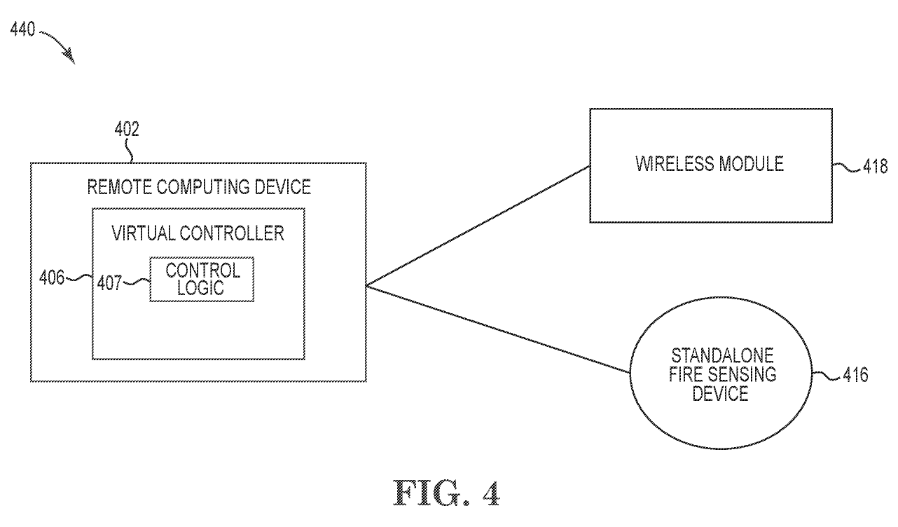

FIG. 4 illustrates an example of a fire alarm system 440 including a virtual controller based fire panel in accordance with an embodiment of the present disclosure. Remote computing device 402 may be remote computing device 302 as described in connection with FIG. 3, for example.

Remote computing device 402 may include virtual controller 406. Virtual controller 406 may include control logic 407 for managing the operation of wireless module 418 and standalone fire sensing device 416. Remote computing device 402 may be a cloud-based computing device for managing standalone fire sensing device 416.

Standalone fire sensing device 416 may be an IOT based sensor located in a separate location from remote computing device 402. Standalone fire sensing device 416 may be standalone fire sensing device 316 as described in connection with FIG. 3, for example. Standalone fire sensing device 416 may communicate directly with virtual controller 406 without the need for a gateway device or fire loop control module. Standalone fire sensing device 416 may communicate with virtual controller through any suitable wireless protocol.

Standalone fire sensing device 416 may detect (e.g., sense) fire alarm events and communicate an indication of a detected fire alarm event to virtual controller 406. In response to receiving the indication that a fire alarm event is occurring, virtual controller 406 may activate a wireless module 418 associated with standalone fire sensing device 416. For example, wireless module may be a sound device associated with standalone fire sensing device 416 that when activated, may emit a sound to alert those present within a particular range of standalone fire sensing device 416 of the fire alarm event. Wireless module 418 is not limited to a sound device and may be any suitable device that includes a physical indicator for indicating a fire alarm event. A physical indicator may include a sound, colored light, flashing light, or any combination of such to provide an indication of a fire alarm event.

As an example, remote computing device 402 may include virtual controller 406 storing control logic 407 that when executed, causes the virtual controller 406 to receive an indication of a fire alarm event from a standalone fire sensing device 416 and send a control command to the standalone fire sensing device 416 to initiate a response to the fire alarm event by the standalone fire sensing device 416 and/or wireless module 418. The response to the fire alarm event may comprise activating a wireless module 418 located on-premise with the standalone fire sensing device 416, for example.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A remote computing device for a fire alarm system, comprising:
a virtual controller storing control logic that when executed, causes the virtual controller to:
receive an indication of a fire alarm event from a standalone fire sensing device; and
send a control command to the standalone fire sensing device to initiate a response to the fire alarm event by the standalone fire sensing device.

2. The remote computing device of claim 1, wherein the response to the fire alarm event comprises activating a wireless module located on-premises with the standalone fire sensing device.

3. The remote computing device of claim 1, wherein the virtual controller is configured to manage a plurality of fire sensing devices wired in a loop via a fire loop control module in communication with the plurality of fire sensing devices wired in the loop.

4. The remote computing device of claim 3, wherein the fire loop control module includes control logic to control the plurality of fire sensing devices wired in the loop during a failure event of the virtual controller.

5. The remote computing device of claim 1, wherein the remote computing device is a cloud-based computing device.

6. The remote computing device of claim 1, wherein the remote computing device is wirelessly connected to the standalone fire sensing device.

7. A fire alarm system, comprising:
a remote computing device including a central control unit and a plurality of virtual controllers;
a gateway device in communication with the remote computing device and a plurality of fire loop control modules; and
a different respective plurality of fire sensing devices in communication with each respective one of the plurality of fire loop control modules,
wherein each respective one of the plurality of fire loop control modules are configured to receive control commands from a virtual controller of the plurality of virtual controllers via the gateway device for controlling the plurality of fire sensing devices in communication with that respective fire loop control module.

8. The fire alarm system of claim 7, wherein the plurality of virtual controllers are configured to:
receive an indication of a fire alarm event from a fire loop control module;
run cause and effect logic in response to receiving the indication of the fire alarm event from the fire loop control module; and
send a control command to the fire loop control module to initiate a response to the fire alarm event by the plurality of fire sensing devices in communication with that respective fire loop control module.

9. The fire alarm system of claim 8, wherein the response comprises activating the plurality of fire sensing devices in communication with that respective fire loop control module.

10. The fire alarm system of claim 8, wherein the response comprises deactivating the plurality of fire sensing devices in communication with that respective fire loop control module.

11. The fire alarm system of claim 7, wherein a virtual controller of the plurality of virtual controllers is configured to control a number of the plurality of fire loop control modules in parallel.

12. The fire alarm system of claim 7, wherein, during a failure event of the remote computing device, each respective one of the plurality of fire loop control modules are configured to control the plurality of fire sensing devices in communication with that respective fire loop control module.

13. The fire alarm system of claim 7, wherein the central control unit includes logic to manage the plurality of virtual controllers.

14. The fire alarm system of claim 7, wherein, during a failure event of a virtual controller of the plurality of virtual controllers, the central control unit is configured to select a different virtual controller of the plurality of virtual controllers to control the fire loop control module of the plurality of fire loop control modules controlled by the virtual controller having the failure event.

15. The fire alarm system of claim 7, wherein:
the gateway device, the plurality of fire loop control modules, and the plurality of fire sensing devices are located on-site within a facility; and
the remote computing device is located remotely from the facility.

16. A method, comprising:
receiving, by a virtual controller of a fire system, an indication of a fire alarm event occurring via a fire loop control module in communication with a plurality of fire sensing devices;
determining, by the virtual controller, a response to the fire alarm event; and
sending, by the virtual controller, a control command to the fire loop control module to initiate the response to the fire alarm event by at least one of the plurality of fire sensing devices.

17. The method of claim 16, wherein the response comprises activating a physical indicator on at least one of the plurality of fire sensing devices.

18. The method of claim 16, wherein the response comprises deactivating a physical indicator on at least one of the plurality of fire sensing devices.

19. The method of claim 16, wherein the plurality of fire sensing devices are in a wireless loop configuration.

20. The method of claim 16, further comprising:
receiving, by the virtual controller, another indication of the fire alarm event occurring via a different fire loop control module in communication with a different plurality of fire sensing devices;
determining, by the virtual controller, an additional response to the fire alarm event; and
sending, by the virtual controller, a control command to the different fire loop control module to initiate the additional response to the fire alarm event by at least one of the different plurality of fire sensing devices.
